(19) United States
(12) Patent Application Publication
(10) Pub. No.: US 2009/0326981 A1
(43) Pub. Date: Dec. 31, 2009

(54) UNIVERSAL HEALTH DATA COLLECTOR AND ADVISOR FOR PEOPLE

(75) Inventors: Chris Demetrios Karkanias, Sammamish, WA (US); Eric J. Horvitz, Kirkland, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/147,655

(22) Filed: Jun. 27, 2008

(51) Int. Cl. G06Q 50/00

(52) U.S. Cl. 705/3

(57) ABSTRACT

The claimed subject matter provides a system and/or a method that facilitates collecting a portion of health data from a collection of users. An interface component can receive health data communicated from a collection of users, wherein each user within the collection is associated with a respective portion of health data. A verification component can authenticate at least one of a transmission source of the portion of health data, an ownership between a portion of health data and a user, an integrity level associated with the portion of health data, or a user submitting the portion of health data. A collection component can aggregate authenticated health data into a semantic data store in which the health data is indicative of a raw and unmolested source of health information from the collection of users. The collection component can further organize the health data to facilitate identification of a medical related trend.

### BACKGROUND

Technological advances in computer hardware, software and networking have lead to increased demand for electronic information exchange rather than through conventional techniques such as paper correspondence, for example. Such electronic communication can provide split-second, reliable data transfer between essentially any two locations throughout the world. Many industries and consumers are leveraging such technology to improve efficiency and decrease cost through web-based (e.g., on-line) services. For example, consumers can purchase goods, review bank statements, research products and companies, obtain real-time stock quotes, download brochures, etc. with the click of a mouse and at the convenience of home.

In light of such technological advances, people in general tend to be more and more concerned about incorporating such technology into their everyday lives. For example, cell phones, handhelds, wireless Internet, portable digital assistants (PDAs), and the like have enabled people to increase productivity and decrease downtime. Furthermore, these devices can provide a continuous access to information which can enable people to be more educated in making decisions about complex matters—such complex matters that typical would require large quantities of time to evaluate or even a particular expertise gained from years of practice. For instance, purchasing stocks or commodities online is now frequently performed by large numbers of people referred to as “day traders,” wherein such purchases are normally made by each individual's research (e.g., real-time stock monitoring, websites, published materials, trends, market analysis, etc.) rather than leveraging a stock broker or similar professional.

In particular, society has increasingly pushed toward being more conscious of his or her health and fitness. Many vastly differing concerns exist, such as setting and obtaining personal fitness goals, long-term health goals, condition management, health monitoring, work-out tracking, etc. Merging personal health management into technology has slowly emerged in the forms of devices, applications, software, or interactive websites. Yet, such techniques are typically implemented in an isolated environment for each individual. For example, a cellular device can include a work-out monitoring application (e.g., leveraging an accelerometer, global positioning service (GPS), timer, etc.) in which details or information related to a particular user's workout can be tracked for his or her personal evaluation.

Such isolated instances are common place within the medical or health field. For example, clinical studies or trials traditionally involve clean data, wherein such clean data follows a “clean room effect” under pre-defined circumstances, characteristics, and/or carefully monitored conditions. Although these clinical studies and trials can provide helpful insight and guidance within the medical arena, a true gage or indication on the device or drug is not fully understood based in part upon such evaluation being a “controlled” study.

### SUMMARY

The following presents a simplified summary of the innovation in order to provide a basic understanding of some aspects described herein. This summary is not an extensive overview of the claimed subject matter. It is intended to neither identify key or critical elements of the claimed subject matter nor delineate the scope of the subject innovation. Its sole purpose is to present some concepts of the claimed subject matter in a simplified form as a prelude to the more detailed description that is presented later.

The subject innovation relates to systems and/or methods that facilitate gathering health data from individuals and evaluating two or more collections of health data to identify a medical related trend. In general, the claimed subject matter can collect and aggregate health related statistics or data from an entire population without relying solely upon doctor or medical professional visits/appointments for relevant information. The collected health data or information can be, for instance, lightweight data. In a particular example, a Bluetooth-enabled sleep apnea detector can be used to gather lightweight data (e.g., O₂ levels in the blood, duration of sleep, heart rate, sleep cycle monitoring, etc.) from a large population of individuals. This aggregated health data from the large population can be used to identify correlations in intermittent events/factors that occur to most people but are largely ignored or generally thought to be too negligible to consider or report. For example, it might be there is a correlation between O₂ levels during sleep and bad days or headaches the following day. Thus, the subject innovation can enable a medical related trend to be identified based on the large population of individuals utilized to gather information.

A collection component can receive a portion of health data via an interface, wherein the portion of health data can be communicated from a specific user. This received data can be validated and/or authenticated by a verification component 104 in order to ensure integrity and security. Generally, the verification component 104 can authenticate a source that communicates health data, the health data, the relationship or ownership between a user and the health data, and/or the user submitting the health data. Upon verification, the data can be organized and stored within a data store, wherein the collection component can identify a medical related trend based upon analysis of the aggregated health data. Moreover, an evaluation engine can analyze the health data in order to provide a predicted outcome, medical advice, a trend, and/or any other health related information from a medical viewpoint. In other aspects of the claimed subject matter, methods are provided that facilitate predicting a medical related outcome from a data set of health information from a population of individuals.

The following description and the annexed drawings set forth in detail certain illustrative aspects of the claimed subject matter. These aspects are indicative, however, of but a few of the various ways in which the principles of the innovation may be employed and the claimed subject matter is intended to include all such aspects and their equivalents. Other advantages and novel features of the claimed subject matter will become apparent from the following detailed description of the innovation when considered in conjunction with the drawings.

### BRIEF DESCRIPTION OF THE DRAWINGS

FIG. 1 illustrates a block diagram of an exemplary system that facilitates aggregating health data from individuals and organizing such information to identify potential medical related trends.

FIG. 2 illustrates a block diagram of an exemplary system that facilitates collecting raw and unmolested health data from a population without influence from a medical professional or community.

FIG. 3 illustrates a block diagram of an exemplary system that facilitates evaluating collected health data in order to predict a reliable outcome or diagnosis for an individual.

FIG. 4 illustrates a block diagram of an exemplary system that facilitates leveraging a social network to collect health data and/or provide calculated health related trends or outcomes.

FIG. 5 illustrates a block diagram of exemplary system that facilitates collecting health data from a user via devices in accordance with an aspect of the subject innovation.

FIG. 6 illustrates a block diagram of an exemplary system that facilitates leveraging inference technologies in order to provide predictive analysis on health data to determine potential trends, outcomes, and/or diagnosis.

FIG. 7 illustrates an exemplary methodology for collecting raw and unmolested health data from a population without influence from a medical professional or community.

FIG. 8 illustrates an exemplary methodology that facilitates evaluating collected health data in order to predict a reliable outcome or diagnosis for an individual.

FIG. 9 illustrates an exemplary networking environment, wherein the novel aspects of the claimed subject matter can be employed.

FIG. 10 illustrates an exemplary operating environment that can be employed in accordance with the claimed subject matter.

### DETAILED DESCRIPTION

The claimed subject matter is described with reference to the drawings, wherein like reference numerals are used to refer to like elements throughout. In the following description, for purposes of explanation, numerous specific details are set forth in order to provide a thorough understanding of the subject innovation. It may be evident, however, that the claimed subject matter may be practiced without these specific details. In other instances, well-known structures and devices are shown in block diagram form in order to facilitate describing the subject innovation.

As utilized herein, terms “component,” “system,” “data store,” “engine,” “device,” “cloud,” and the like are intended to refer to a computer-related entity, either hardware, software (e.g., in execution), and/or firmware. For example, a component can be a process running on a processor, a processor, an object, an executable, a program, a function, a library, a subroutine, and/or a computer or a combination of software and hardware. By way of illustration, both an application running on a server and the server can be a component. One or more components can reside within a process and a component can be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter. Moreover, the word “exemplary” is used herein to mean serving as an example, instance, or illustration. Any aspect or design described herein as “exemplary” is not necessarily to be construed as preferred or advantageous over other aspects or designs.

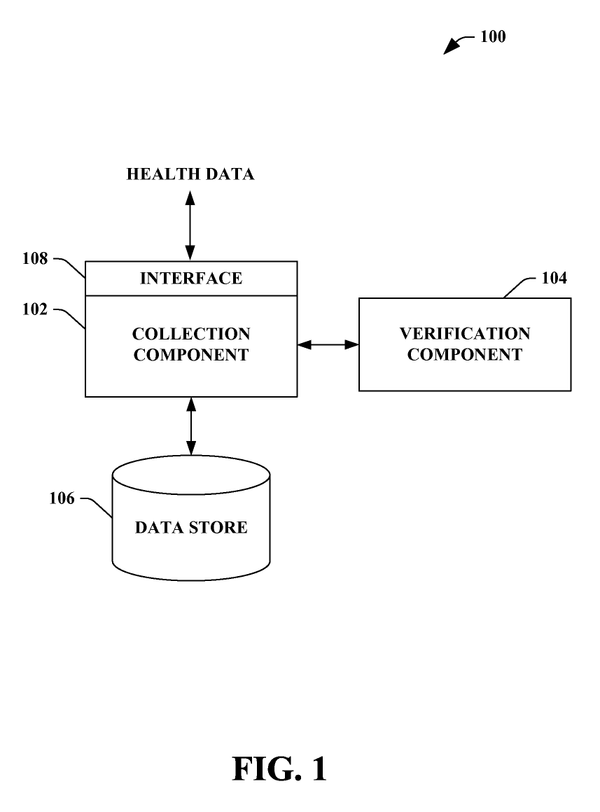

Now turning to the figures, FIG. 1 illustrates a system 100 that facilitates aggregating health data from individuals and organizing such information to identify potential medical related trends. The system 100 can include a collection component 102 that can aggregate health data from a plurality of disparate users in order to provide medical or health information. In particular, the collection component 102 can receive health data via an interface component 108 (discussed in more detail below) in which such health data can be communicated from a particular user or individual. The aggregated health data indicative of numerous users, with each user having respective health data, can be authenticated by a verification component 104. The verification component 104 can validate at least one of a source of the communicated health data, the health data integrity, a user submitting the health data, a relationship between a user and the health data, and/or any other suitable verification associated with the collection of data from a source via a connection (e.g., the Internet, a server, a network, a device, a wireless transmission, etc.).

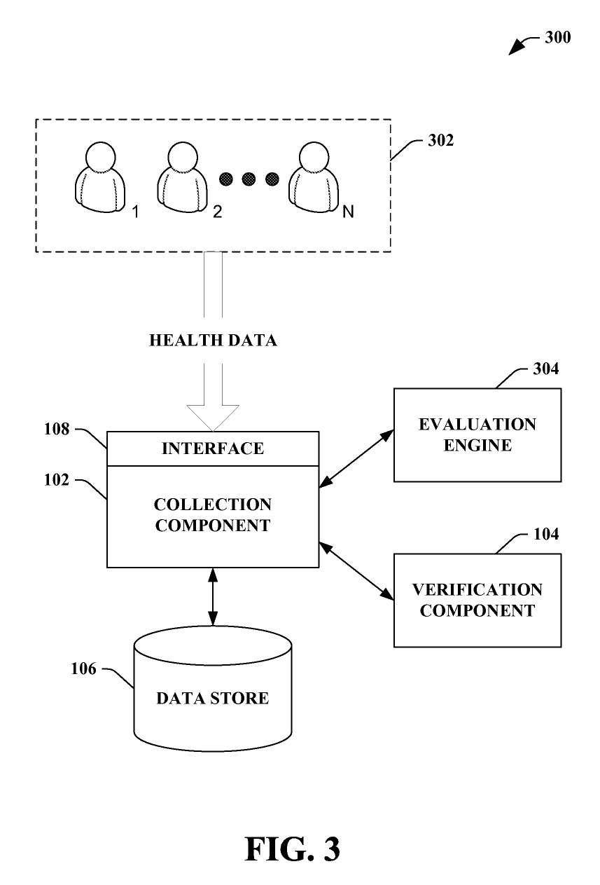

Upon collection and authentication, the health data can be organized by the collection component 102 within a data store 106 (discussed in more detail below) to facilitate identification of correlations, relationships, etc. Specifically, the collection component 102 can categorize and/or sort data based on various characteristic associated with the health data (e.g., source, user, user details, context, content, etc.). The collection component 102 can further evaluate such health data in order to predict outcomes, provide medical related trends, determine diagnosis, generate advice, translate situations, and/or provide reliable insight from a medical viewpoint. It is to be appreciated that such evaluation and analysis is discussed in more detail in FIG. 3.

It is to be appreciated that the health data communicated can be considered raw and unmolested in that a medical professional or organization is not affiliated with such data collection. In other words, typical health data collection is monitored, filtered, or screened in order to provide a “clean room” affect as implemented in clinical studies or trials. Yet, the system 100 allows a population to contribute health data without restrictions, standards, or criteria that must be met (other than being authenticated or verified). The system 100 can allow a seamless and universal collection of health data from a plurality of users, wherein health data for each user can include distinct and specific health or wellness information. This pool or collection of health data can allow evaluation and analysis to be conducted on data regardless of content, context, source, format, etc.

As mentioned, the health data can be, for instance, lightweight data or low resolution data such as an emotion (e.g., sad, happy, depressed, etc.) or feeling (e.g., arm pain, headache, upset stomach, etc.) communicated to the system 100 from a particular user. By aggregating such lightweight data from multiple users, correlations, relationships, etc. can be generated in order to provide medical evaluations (e.g., predict outcomes, provide medical related trends, determine diagnosis, generate advice, translate situations, provide reliable insight from a medical viewpoint, etc.). In other words, lightweight data from a user over time in combination with lightweight data from a plurality of users over time can enable insightful and reliable medical prognosis based upon analysis and evaluation of such collected health data.

In another example, a Bluetooth-enabled sleep apnea detector can be used to gather lightweight data (e.g., O₂ levels in the blood, duration of sleep, heart rate, sleep cycle monitoring, etc.) from a large population of individuals. This aggregated health data from the large population can be used to identify correlations in intermittent events/factors that occur to most people but are largely ignored or generally thought to be too negligible to consider or report. For example, it might be there is a correlation between O₂ levels during sleep and bad days or headaches the following day. Thus, the subject innovation can enable a medical related trend to be identified based on the large population of individuals utilized to gather information.

The system 100 can further include a data store 106 that can include any suitable data utilized or interacted with by the collection component 102, the verification component 104, the interface 108, etc. For example, the data store 106 can include, but not limited to including, health data (e.g., low resolution data, lightweight data, etc.), user data, user demographic data, user profile data, user settings, user configurations, user preferences, health data access preferences, verification techniques (e.g., human interactive proofs, security data, security question data, etc.), modeling data (e.g., user specific models, general models for a user type, etc.), health data collection settings, opt-in settings for users, solicitation for health data settings, third-party healthcare information, dynamic health data collected, inference data, demographic data, device data (e.g., device settings, health data collection configurations), etc.

It is to be appreciated that the data store 106 can be, for example, either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable programmable ROM (EEPROM), or flash memory. Volatile memory can include random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM). The data store 106 of the subject systems and methods is intended to comprise, without being limited to, these and any other suitable types of memory. In addition, it is to be appreciated that the data store 106 can be a server, a database, a hard drive, a pen drive, an external hard drive, a portable hard drive, and the like.

The data store 106 can further be a semantic data store in which the meaning of the collected health data can be stored as facts about objects. In general, the data store 106 can include the following characteristics: semantic binary model, object-oriented features, semantically-enhanced object-relational, a collection of facts, arbitrary relationships, storing the inherent meaning of information, information in a natural form, information handling system, relationships between classes, no data size restriction, no data type restriction, ad hoc query, viewable relations, and/or no keys needed. It is to be further appreciated that any suitable number of data stores 106 can be implemented with the subject innovation, wherein the data stores can be a semantic data store, a relational data store, and/or any suitable combination thereof.

In addition, the system 100 can include any suitable and/or necessary interface component 108, which provides various adapters, connectors, channels, communication paths, etc. to integrate the collection component 102 into virtually any operating and/or database system(s) and/or with one another. In addition, the interface component 108 can provide various adapters, connectors, channels, communication paths, etc., that provide for interaction with the collection component 102, the verification component 104, the data store 106, and any other device and/or component associated with the system 100.

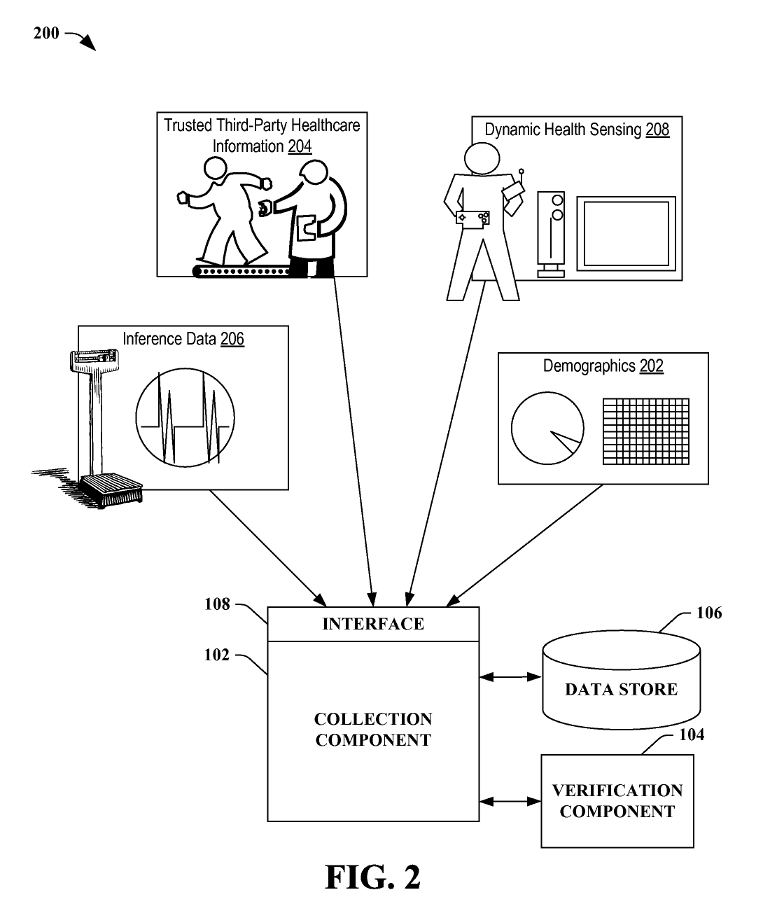

FIG. 2 illustrates a system 200 that facilitates collecting raw and unmolested health data from a population without influence from a medical professional or community. The system 200 can include the collection component 102 that can aggregate and organize health data from a population of users. Such collected health data can be authenticated by the verification component 104 in order to ensure data and/or system integrity while maintaining a confident level of security. In general, the system 200 can aggregate lightweight health data that can, in large quantities across a broad population of individuals, can be evaluated to identify medical trends, outcomes, prognosis, diagnosis, and/or any other relevant advice from a medical viewpoint.

The system 200 can gather any suitable type of health data from a user that indicates health or wellness. In general, the health data can be lightweight (e.g., low resolution data), non-lightweight data (e.g., high resolution data), and/or any suitable combination thereof. It is to be appreciated that the health data can include at least one of a portion of text, a portion of audio, a portion of video, a portion of imagery, and/or any suitable combination thereof.

The health data can further include emotional data (e.g., feelings, emotions, conditions, etc.). For instance, such health data can be a emotional data that is descriptive of user's condition/state, such as, but not limited to, happy, sad, cheerful, depressed, giddy, mad, angry, excited, nervous, headache, physical pain, mental anguish, tired, refreshed, sore, achy, alert, weak, strong, irritable, shaky, exercise data (e.g., duration of workout, type of workout, etc.), etc. Moreover, the health data can be physiological data (e.g., medical related measurements, statistics, levels, etc.). For instance, such health data can be demographic data (e.g., height, weight, body part measurements, etc.), a heart rate, a blood pressure reading, vital signs, a body temperature, a skin temperature, respiration rate (e.g., rate of breathing), body fat percentage, body inductance, reflexes, eyesight measurements, strength rating, blood evaluation (e.g., oxygen levels, substance level within blood, pH values, acid level, alkaline level, sodium level, chloride ion level, blood glucose level, etc.), sodium level, glucose levels, toxic levels within a body, cardiovascular system monitoring, pulmonary system monitoring, cellular respiration tracking, hormonal level, anti-diuretic hormone (ADH) reading, carbon dioxide levels, tidal volume, lung capacity, electrocardiogram data, spirometer data, peak flow meter data, sinus tachycardia data, bradycardia data, sinus arrhythmia data, health readings during exercise, and/or any other data related to a medical measurement or medical condition.

The health data can be detected by various applications, devices, components, and the like. In one example, health data can be collected from a device that specifically gathers or dynamically collects health data (e.g., a heart monitor, a sphygmomanometer, a respirator, a thermometer, etc.). In another example, health data can be collected by an item or device with health data collection capabilities or potential (e.g., a cellular device, an application, a portion of software, a mobile device, a gaming console, a portable gaming device, a media player, a communication device, a pager, a messaging device, a watch, a ring, an article of clothing, a portable digital assistant (PDA), a smartphone, an item of jewelry, a global positioning system (GPS) device, an accelerometer, a motion detector, a sensor, etc.), etc.

For example, a user can communicate health data with an electronic device such as a smartphone, computer, laptop, and the like, wherein such data can be submitted via the Internet (e.g., email, website, upload, network, etc.). In other words, health data can be communicated and received by any electronic device with access to the Internet. As mentioned, the interface 108 can receive communicated health data from a user, wherein such health data can be communicated by any suitable connection (e.g., wireless, Bluetooth, infrared, hard-link, cable, universal serial port, Internet, server, etc.) across any suitable medium.

In a particular example, a user can send a text message “Feeling well today” to the system 200 in which such health data can be aggregated and utilized to provide medical information. In another example, an email with pictures depicting a rash can be communicated to the system 200. Further, a video including footage of an individual sustaining a minor injury can be communicated (e.g., a person sliding into a base while playing softball and injuring his or her ankle, etc.).

In another example, the system 200 can include an extractor component (not shown) that can monitor data on a machine (e.g., a computer, a laptop, a mobile device, a smartphone, an email application, a text messaging application, a data store, a document, a communication, etc.) in order to identify any suitable data that can be utilized as health data. Thus, the extractor component can analyze data on a smartphone (e.g., emails, text messages, documents, notes, calendar data, etc.) in order to locate and communicate health related data to the system 200. Thus, a text message responding to a friend stating “I am so tired today and my foot hurts from soccer,” can be communicated to the system 200.

Moreover, an article of clothing can be utilized to collect or gather health data. For example, a pair of shoes can include components such as, but not limited to, an accelerometer and a GPS device. Such health data collecting shoes can gather health data such as distance walked, distance ran, duration of exercise, speed, calories burned, and the like, which can be communicated and utilized with the system 200 to facilitate providing health or fitness information. In a similar example, a shirt can include sensors to measure perspiration and activity, which can be communicated for health analysis.

In another example, a watch can include a pedometer that can detect health and/or fitness data such as distance walked or ran. This watch can detect health data which can be communicated (e.g., wirelessly, hard-connection, Bluetooth, etc.) to the system 200. Upon collection, the system 200 can aggregate and store such health data which can further be utilized to provide medical insight in light of a collection of substantially similar health data from a plurality of individuals. For instance, the system 200 can determine that a user can increase a distance walked by half a mile in order to reduce a risk associated with heart disease.

As depicted and described above, the system 200 can gather health data from a wealth of devices, sources, agencies, parties, components, etc. A demographics portion of health data 202 can be received can utilized by the collection component 102. The demographics portion of health data 202 can include physical characteristics such as age, sex, weight, height, body fat percentage, lifestyle data (e.g., recreational activities, activity level, exercise information, average blood alcohol content, etc.), employment experience, occupation, political affiliations, ethnicity, race, nationality, geographic home, current residence, etc. The collection component 102 can also receive a trusted third-party healthcare information 204. Such trusted third-party healthcare information can be received (upon specific user approval) and utilized for further analysis. For instance, trusted third-party healthcare information can be medical records, conditions, medical files, data collected from medical visits, prior prognosis, prior diagnosis, charts, x-rays, scans, etc.

The system 200 can further access inference data 206 which can be any suitable health data inferred based upon a user's activity (e.g., eating habits, exercise, daily activity, etc.). For instance, a bracelet worn during exercising that incorporates measures for a period of elevated pulse equating to exercise, miles run as detected by a pedometer, running as detected by from a location sensing system (e.g., global positioning system (GPS) device) can be leveraged to collect health data. As yet a further example, health data can be gathered with a dynamic health or mood sensing component 208. As discussed above, any suitable component can be implemented in order to gather health-related data in real time.

It is to be appreciated and understood that each user can select a health data aggregation settings to his or her preference (e.g., privacy settings, etc.). For example, a first user may not want to opt-in to allow trusted third-party healthcare information, whereas a second user may want to allow trusted third-party healthcare information to be utilized. In other words, each user can include a healthcare data submission profile particular to his or her needs. Moreover, the system 200 can provide automatic solicitation of health data (e.g., request to a user to submit health data, automatic retrieval of health data, with specific periodic collection durations, etc.), a manual technique for communicated health data (e.g., user submits or communicates health data, etc.), and/or any suitable combination thereof. For example, a user can allow the following: trusted third-party healthcare information to be automatically communicated to the system 200 on a monthly basis (e.g., or any other suitable duration or trigger event, trigger event such as new medical data available, etc.); a reminder email to provide a brief description of his or her emotions; and/or a manual communication for a media player with a workout tracking application.

Furthermore, the system 200 can employ a privacy technique in order to share and/or submit health data in accordance to a user's preference for security or privacy setting. For example, a user can provide anonymity in connection with disparate users from a population. The user can also allow a partial exposure of information (e.g., a username, an avatar, a description, etc.). The user can allow a full exposure of information while not exposing vulnerability to identify theft or other security breaches. In general, the system 200 can allow each user to have specific privacy settings particular to his or her preference. In one example, a user can have a first set of information public to users associated with a contact list (e.g., a list of users actively approved by the user) and a second set of information private to such contact list and other users related to the system 200.

FIG. 3 illustrates a system 300 that facilitates evaluating collected health data in order to predict a reliable outcome or diagnosis for an individual. The system 300 can include the collection component 102 that can leverage health data from a plurality of users 302 in order to create correlations, relationships, and/or outcomes based upon the health data gathered. The plurality of users 302 can include any suitable number of users, such as user₁, user₂, to user_{N}, where N is a positive integer. By collecting health data that is raw, unmolested, and/or influenced by a medical entity (e.g., medical facility, medical professional, medical affiliated individual, etc.), the system 300 can provide medical insight on a general population of users.

The system 300 can further include an evaluation engine 304 that can identify relationships, correlations, and/or potential conclusions/outcomes from the collected health data. In general, by leveraging a large sample of data from the plurality of users 302, the evaluation engine 304 can predict outcomes, provide medical related trends, determine diagnosis, generate advice, translate situations, and/or provide reliable insight from a medical viewpoint. It is to be appreciated that the evaluation engine 304 can examine health data (and/or associated metadata) in order to glean information to assist in evaluation and/or sorting. The evaluation engine 304 can further employ any suitable inference technique (discussed in more detail below) such as, but not limited to, Bayesian theory, neural networks, etc.

Furthermore, the evaluation engine 304 can utilize created models to facilitate identifying relationships, correlations, etc. between users. For instance, the evaluation engine 304 can create a model specific to each user. In another example, the evaluation engine 304 can create a generic model that can reflect a template or characteristics indicative of a particular category or profile. For example, an athletic template or generic model can include configurations that are reflective of an athletic user. In another example, a user can select a generic model or template and personally tailor such model. In addition, a user can be automatically fit to a generic model and the system 300 can adapt or manipulate the model to the particular user. It is to be appreciated that the models can be created or manipulated based upon any suitable criteria gleaned from the user and/or health data collected from such user.

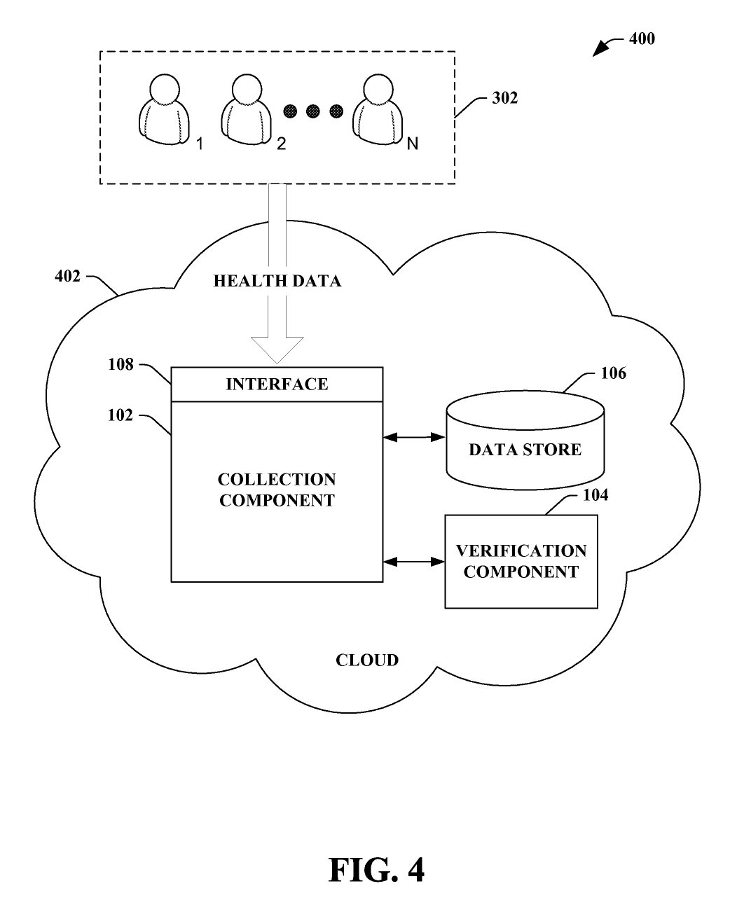

FIG. 4 illustrates a system 400 that facilitates leveraging a social network to collect health data and/or provide calculated health related trends or outcomes. The system 400 can utilize a cloud 402 that can incorporate at least one of the collection component 102, the verification component 104, the data store 106, the interface 108, and/or any suitable combination thereof. It is to be appreciated that the cloud 402 can include any suitable component, device, hardware, and/or software associated with the subject innovation. The cloud 402 can refer to any collection of resources (e.g., hardware, software, combination thereof, etc.) that are maintained by a party (e.g., off-site, on-site, third party, etc.) and accessible by an identified user over a network (e.g., Internet, wireless, LAN, cellular, Wi-Fi, WAN, etc.). The cloud 402 is intended to include any service, network service, cloud service, collection of resources, etc. and can be accessed by an identified user via a network. For instance, two or more users can access, join, and/or interact with the cloud 402 and, in turn, at least one of the collection component 102, the verification component 104, the data store 106, the interface 108, and/or any suitable combination thereof. In addition, the cloud 402 can provide any suitable number of service(s) to any suitable number of user(s) and/or client(s). In particular, the cloud 402 can include resources and/or services that enable health data aggregation from a plurality of disparate users in order to provide medical or health information.

Generally, the cloud 402 can provide a communications environment or network for any suitable number of users 302 such as user₁, user₂, to user_{N}, where N is a positive integer. In other words, the cloud 402 can be a secure and informative community or forum in which users can submit, share, and/or receive information (e.g., health advice, other user's experiences, health data, etc.). Moreover, as a forum, the cloud 402 can enable two or more users 302 to communicate (e.g., text, chat, video, audio, instant message, etc.). In addition, the cloud 402 can implement an administrator that can monitor, regulate, and/or provide assistance in relation to users and/or activity. For instance, the cloud 402 can be a social network, a networked community, a forum, and the like.

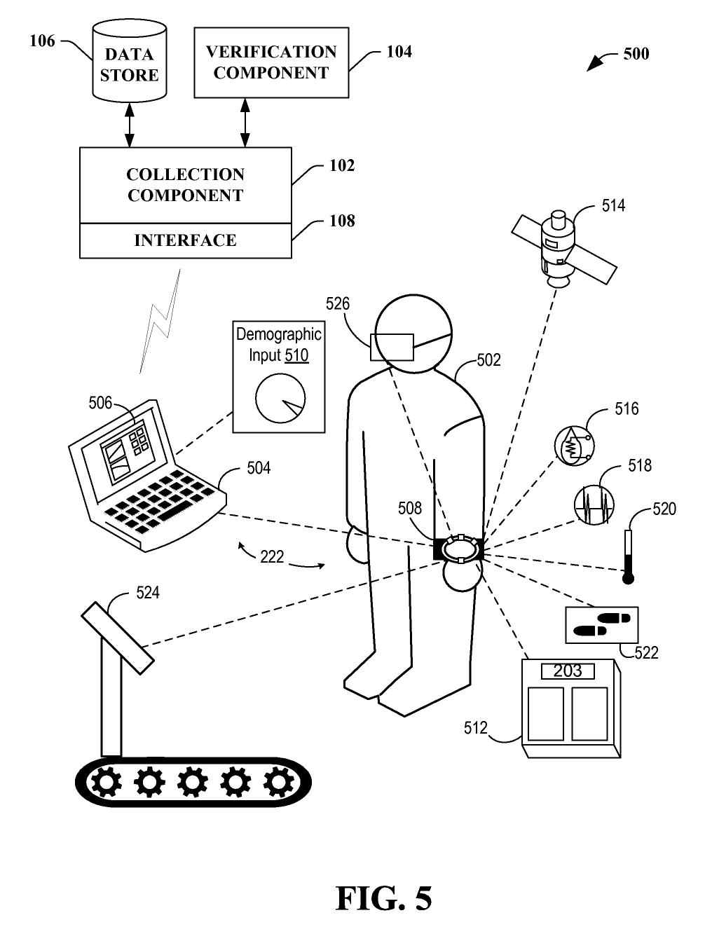

FIG. 5 illustrates a system 500 that facilitates collecting health data from a user via devices in accordance with an aspect of the subject innovation. The system 500 can include a user 502. The user 502 can communicate health data, which can be provided on various kinds of devices, or a plurality of interacting devices. In the illustrative depiction, a general purpose computer, depicted as a laptop 504, executes an application 506 that synchronizes with a portable device 508 that is strapped onto an arm of the user 502 to detect physiological data and/or health data. The combination thus allows additional user interface options and communication of a laptop 504 with the ease of portability of a small portable device 508, such as a Smart Personal Object Technology (SPOT) watch. Alternatively or in addition, the portable device 508 could be used without a laptop 504. As a further alternative, raw physiological data, motion data, or health data detected by a portable sensor could be periodically downloaded to a device that is not worn (e.g., the laptop 504, the interface 108, the collection component 102, etc.) for processing and interaction.

Various manners can be employed to communicate health data and the numerous types of health data. For instance, the user 520 can submit demographic data 510. The user 520 can manually input weight information or a weight scale 512 can wirelessly communicate a weight. The system 500 can include integrated sensors or be in communication with various sensors. For example, motion and location can be enhanced by picking global positioning signals from GPS satellites 514. The system 500 can leverage physiological data from a skin resistance sensor 516, a cardiopulmonary rate sensor (e.g., pulse, respiration rate, etc.) 518, a body temperature sensor 520, and/or a motion sensor (e.g., pedometer, accelerometer) 522. Similar data can be separately obtained and received from exercise equipment, depicted as a treadmill 524. Refinement of estimates can be obtained by interfacing with a respiratory calorimeter 526. The health data can be aggregated and utilized upon communication to the collection component 102 via the interface 108, wherein the communication can be directly from the device 508, the laptop 504, the application 506, and/or any suitable combination thereof.

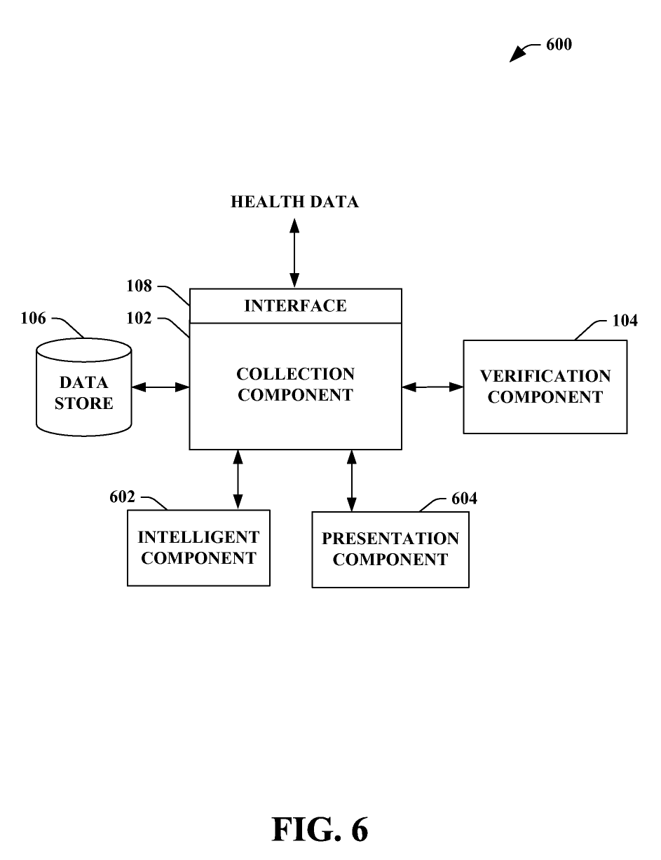

FIG. 6 illustrates a system 600 that facilitates leveraging inference technologies in order to provide predictive analysis on health data to determine potential trends, outcomes, and/or diagnosis. The system 600 can include the collection component 102, the verification component 104, the data store 106, and/or the interface 108, which can be substantially similar to respective components, interfaces, and data stores described in previous figures. The system 600 further includes an intelligent component 602. The intelligent component 602 can be utilized by the collection component 102 to facilitate collecting, authenticating, securing, and/or organizing health data from a plurality of disparate users within a population. In addition, the intelligent component 602 can facilitate generating at least one of a trend, a predicted outcome, a relationship, a correlation, and/or any other medical advice ascertained by evaluating collected health data. For example, the intelligent component 602 can infer user health data collection preferences (e.g., duration, frequency, sources, device settings, type of data, etc.), user security preferences (e.g., user profile data, username, password, security question, etc.), authentication settings (e.g., source verification, health data verification, user verification, etc.), user privacy settings (e.g., contact list, data exposure for contacts, etc.), value of health data (e.g., which health data to collect, identification of useful health data, etc.), modeling, user specific model, template models, generic models, modification to a model to adapt to a user, semantic relationships, semantic storage of health data, sorting of health data, organization of health data, VOI of health data in accordance to a particular user, device settings, evaluation of health data, predicted outcomes, relationships between health data and a user, correlations between health data and a user, reliability of an ascertained outcome, medical advice, medical insight based upon gathered health data, a trend ascertained from gathered medical data, cloud settings, social network configurations (e.g., communications, connections, etc.), health data, workout data, fitness data, health related advice, medical recommendations, etc.

The intelligent component 602 can employ value of information (VOI) computation in order to identify a most valuable trend, relationship, correlation, outcome, and/or medical insight on a situation. For instance, by utilizing VOI computation, the most ideal and/or appropriate medical information gleaned from health data can be ascertained. Moreover, it is to be understood that the intelligent component 602 can provide for reasoning about or infer states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification (explicitly and/or implicitly trained) schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

The collection component 102 can further utilize a presentation component 604 that provides various types of user interfaces to facilitate interaction between a user and any component coupled to the collection component 102. As depicted, the presentation component 604 is a separate entity that can be utilized with the collection component 102. However, it is to be appreciated that the presentation component 604 and/or similar view components can be incorporated into the collection component 102 and/or a stand-alone unit. The presentation component 604 can provide one or more graphical user interfaces (GUIs), command line interfaces, and the like. For example, a GUI can be rendered that provides a user with a region or means to load, import, read, etc., data, and can include a region to present the results of such. These regions can comprise known text and/or graphic regions comprising dialogue boxes, static controls, drop-down-menus, list boxes, pop-up menus, as edit controls, combo boxes, radio buttons, check boxes, push buttons, and graphic boxes. In addition, utilities to facilitate the presentation such as vertical and/or horizontal scroll bars for navigation and toolbar buttons to determine whether a region will be viewable can be employed. For example, the user can interact with one or more of the components coupled and/or incorporated into the collection component 102.

The user can also interact with the regions to select and provide information via various devices such as a mouse, a roller ball, a touchpad, a keypad, a keyboard, a touch screen, a pen and/or voice activation, a body motion detection, for example. Typically, a mechanism such as a push button or the enter key on the keyboard can be employed subsequent entering the information in order to initiate the search. However, it is to be appreciated that the claimed subject matter is not so limited. For example, merely highlighting a check box can initiate information conveyance. In another example, a command line interface can be employed. For example, the command line interface can prompt (e.g., via a text message on a display and an audio tone) the user for information via providing a text message. The user can then provide suitable information, such as alpha-numeric input corresponding to an option provided in the interface prompt or an answer to a question posed in the prompt. It is to be appreciated that the command line interface can be employed in connection with a GUI and/or API. In addition, the command line interface can be employed in connection with hardware (e.g., video cards) and/or displays (e.g., black and white, EGA, VGA, SVGA, etc.) with limited graphic support, and/or low bandwidth communication channels.

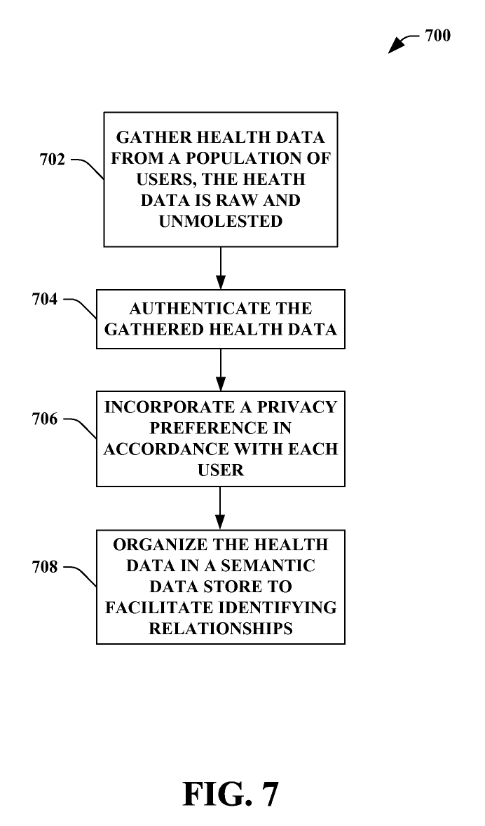

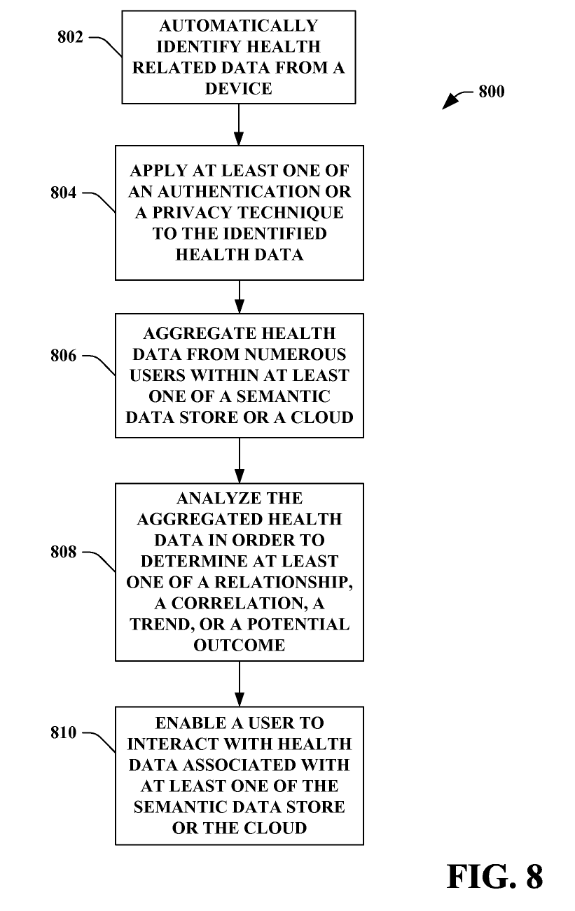

FIGS. 7-8 illustrate methodologies and/or flow diagrams in accordance with the claimed subject matter. For simplicity of explanation, the methodologies are depicted and described as a series of acts. It is to be understood and appreciated that the subject innovation is not limited by the acts illustrated and/or by the order of acts. For example acts can occur in various orders and/or concurrently, and with other acts not presented and described herein. Furthermore, not all illustrated acts may be required to implement the methodologies in accordance with the claimed subject matter. In addition, those skilled in the art will understand and appreciate that the methodologies could alternatively be represented as a series of interrelated states via a state diagram or events. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

FIG. 7 illustrates a method 700 that facilitates collecting raw and unmolested health data from a population without influence from a medical professional or community. At reference numeral 702, health data can be gathered from a population of users, wherein the health data can be raw and unmolested. It is to be appreciated that the health data communicated can be considered raw and unmolested in that a medical professional or organization is not affiliated with such data collection. In other words, typical health data collection is monitored, filtered, or screened in order to provide a “clean room” affect as implemented in clinical studies or trials.

At reference numeral 704, the gathered health data can be authenticated. For instance, at least one of a source of the communicated health data, the health data integrity, a user submitting the health data, a relationship between a user and the health data, and/or any other suitable verification associated with the collection of data from a source via a connection (e.g., the Internet, a server, a network, a device, a wireless transmission, etc.) can be authenticated and/or validated. In general, it is to be appreciated that the authentication can ensure health data is accurate, the health data is associated to an actual user, and/or the health data is secure (e.g., virus-free, etc.).

At reference numeral 706, a privacy preference can be incorporated into the health data in accordance with each user. Such privacy preference can relate to data submission (e.g., source identification for submitted health data, level of traceability for submitted health data, etc.), cloud and/or social network (e.g., contact list, availability identification of user, data exposure from user, demographic data available, amount of data publicly available, etc.), contact settings (e.g., retrieval of health related information, communication settings, etc.), health data settings (e.g., public data, private data, public data to particular users, private data to particular users, data access for evaluation, etc.), and/or any other suitable privacy settings or preference related to health data collection and/or evaluation.

At reference numeral 708, the health data can be organized in a semantic data store in order to facilitate identification of relationships. In particular, the health data collected from the population of users can be aggregated and sorted in order to allow evaluation and/or analysis in order to identify relationships, correlations, trends, and/or predictable outcomes.

FIG. 8 illustrates a method 800 for facilitates evaluating collected health data in order to predict a reliable outcome or diagnosis for an individual. At reference numeral 802, health related data can be automatically identified from a device. In general, a user can interact and/or communicate with a plurality of devices, electronics, and/or machines (e.g., mobile devices, cell phones, computers, instant messaging applications, laptops, email software, automobile navigation systems, etc.). Such interaction and devices can be examined and health-related data can be automatically identified and collected. For example, a text message from a user can be collected based on such text offering an insight on how the user is feeling. In another example, email can be automatically monitored to extract health-related data. Thus, any suitable communication (e.g., audio, video, text, graphic, imagery, etc.) can be automatically evaluated to aggregate health-related data from various devices for a user.

At reference numeral 804, at least one of an authentication or a privacy technique can be applied to the identified health data. At reference numeral 806, health data collected and identified can be aggregated from numerous users within at least one of a semantic data store or a cloud. At reference numeral 808, the aggregated health data can be analyzed to determine at least one of a relationship, a correlation, a trend, or a potential outcome. By aggregating such health data from multiple users, correlations, relationships, etc. can be generated in order to provide medical evaluations (e.g., predict outcomes, provide medical related trends, determine diagnosis, generate advice, translate situations, provide reliable insight from a medical viewpoint, etc.). In other words, health data from a user over time in combination with health data from a plurality of users over time can provide insightful and reliable medical prognosis based upon analysis and evaluation of such collected health data.

At reference numeral 810, a user can be enabled to interact with a portion of health data associated with at least one of the semantic data store or the cloud. For example, a social network or community can be employed in order to allow a user to submit, access, and/or interact with health data. Moreover, the social network or community can allow users to communicate or interact with one another (e.g., email, text messages, posts, blogs, audio, video, imagery, chat, video chat, web cameras, etc.).

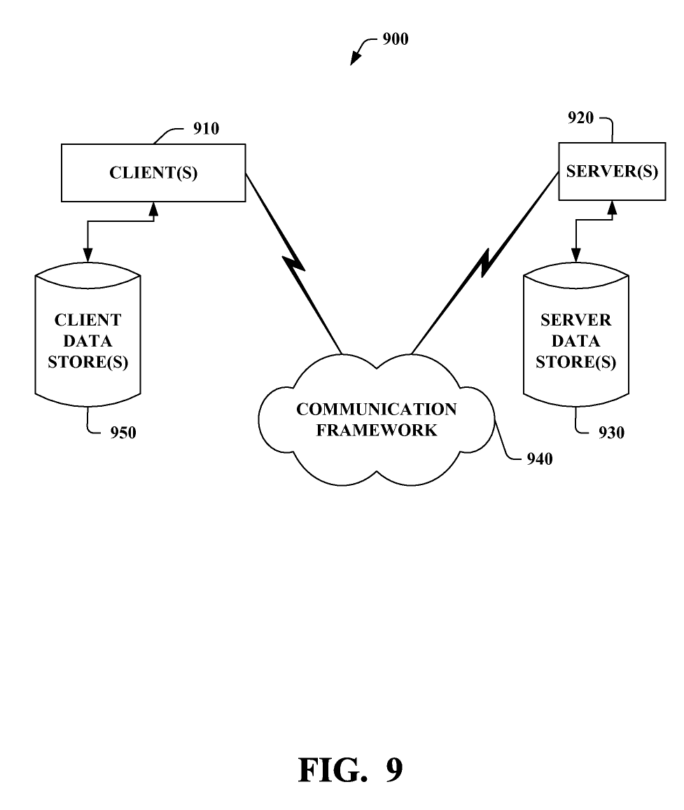

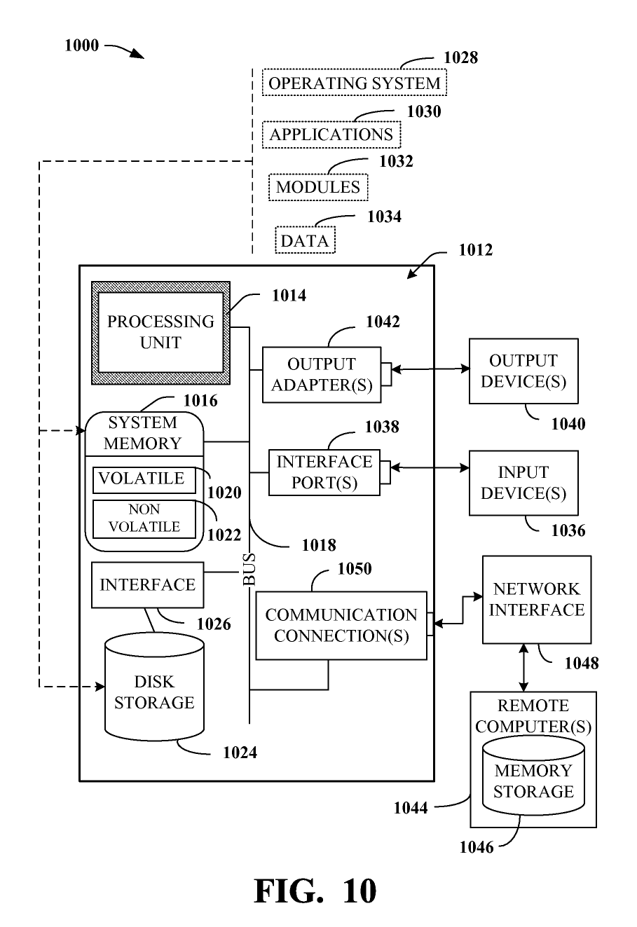

In order to provide additional context for implementing various aspects of the claimed subject matter, FIGS. 9-10 and the following discussion is intended to provide a brief, general description of a suitable computing environment in which the various aspects of the subject innovation may be implemented. For example, collection component that aggregates various health-related data sets from a general population in order to facilitate providing medical insight, as described in the previous figures, can be implemented in such suitable computing environment. While the claimed subject matter has been described above in the general context of computer-executable instructions of a computer program that runs on a local computer and/or remote computer, those skilled in the art will recognize that the subject innovation also may be implemented in combination with other program modules. Generally, program modules include routines, programs, components, data structures, etc., that perform particular tasks and/or implement particular abstract data types.

Moreover, those skilled in the art will appreciate that the inventive methods may be practiced with other computer system configurations, including single-processor or multi-processor computer systems, minicomputers, mainframe computers, as well as personal computers, hand-held computing devices, microprocessor-based and/or programmable consumer electronics, and the like, each of which may operatively communicate with one or more associated devices. The illustrated aspects of the claimed subject matter may also be practiced in distributed computing environments where certain tasks are performed by remote processing devices that are linked through a communications network. However, some, if not all, aspects of the subject innovation may be practiced on stand-alone computers. In a distributed computing environment, program modules may be located in local and/or remote memory storage devices.

FIG. 9 is a schematic block diagram of a sample-computing environment 900 with which the claimed subject matter can interact. The system 900 includes one or more client(s) 910. The client(s) 910 can be hardware and/or software (e.g., threads, processes, computing devices). The system 900 also includes one or more server(s) 920. The server(s) 920 can be hardware and/or software (e.g., threads, processes, computing devices). The servers 920 can house threads to perform transformations by employing the subject innovation, for example.

One possible communication between a client 910 and a server 920 can be in the form of a data packet adapted to be transmitted between two or more computer processes. The system 900 includes a communication framework 940 that can be employed to facilitate communications between the client(s) 910 and the server(s) 920. The client(s) 910 are operably connected to one or more client data store(s) 950 that can be employed to store information local to the client(s) 910. Similarly, the server(s) 920 are operably connected to one or more server data store(s) 930 that can be employed to store information local to the servers 920.

With reference to FIG. 10, an exemplary environment 1000 for implementing various aspects of the claimed subject matter includes a computer 1012. The computer 1012 includes a processing unit 1014, a system memory 1016, and a system bus 1018. The system bus 1018 couples system components including, but not limited to, the system memory 1016 to the processing unit 1014. The processing unit 1014 can be any of various available processors. Dual microprocessors and other multiprocessor architectures also can be employed as the processing unit 1014.

The system bus 1018 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 1016 includes volatile memory 1020 and nonvolatile memory 1022. The basic input/output system (BIOS), containing the basic routines to transfer information between elements within the computer 1012, such as during start-up, is stored in nonvolatile memory 1022. By way of illustration, and not limitation, nonvolatile memory 1022 can include read only memory (ROM), programmable ROM (PROM), electrically programmable ROM (EPROM), electrically erasable programmable ROM (EEPROM), or flash memory. Volatile memory 1020 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 1012 also includes removable/non-removable, volatile/non-volatile computer storage media. FIG. 10 illustrates, for example a disk storage 1024. Disk storage 1024 includes, but is not limited to, devices like a magnetic disk drive, floppy disk drive, tape drive, Jaz drive, Zip drive, LS-100 drive, flash memory card, or memory stick. In addition, disk storage 1024 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1024 to the system bus 1018, a removable or non-removable interface is typically used such as interface 1026.

It is to be appreciated that FIG. 10 describes software that acts as an intermediary between users and the basic computer resources described in the suitable operating environment 1000. Such software includes an operating system 1028. Operating system 1028, which can be stored on disk storage 1024, acts to control and allocate resources of the computer system 1012. System applications 1030 take advantage of the management of resources by operating system 1028 through program modules 1032 and program data 1034 stored either in system memory 1016 or on disk storage 1024. It is to be appreciated that the claimed subject matter can be implemented with various operating systems or combinations of operating systems.

A user enters commands or information into the computer 1012 through input device(s) 1036. Input devices 1036 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1014 through the system bus 1018 via interface port(s) 1038. Interface port(s) 1038 include, for example, a serial port, a parallel port, a game port, and a universal serial bus (USB). Output device(s) 1040 use some of the same type of ports as input device(s) 1036. Thus, for example, a USB port may be used to provide input to computer 1012, and to output information from computer 1012 to an output device 1040. Output adapter 1042 is provided to illustrate that there are some output devices 1040 like monitors, speakers, and printers, among other output devices 1040, which require special adapters. The output adapters 1042 include, by way of illustration and not limitation, video and sound cards that provide a means of connection between the output device 1040 and the system bus 1018. It should be noted that other devices and/or systems of devices provide both input and output capabilities such as remote computer(s) 1044.

Computer 1012 can operate in a networked environment using logical connections to one or more remote computers, such as remote computer(s) 1044. The remote computer(s) 1044 can be a personal computer, a server, a router, a network PC, a workstation, a microprocessor based appliance, a peer device or other common network node and the like, and typically includes many or all of the elements described relative to computer 1012. For purposes of brevity, only a memory storage device 1046 is illustrated with remote computer(s) 1044. Remote computer(s) 1044 is logically connected to computer 1012 through a network interface 1048 and then physically connected via communication connection 1050. Network interface 1048 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1050 refers to the hardware/software employed to connect the network interface 1048 to the bus 1018. While communication connection 1050 is shown for illustrative clarity inside computer 1012, it can also be external to computer 1012. The hardware/software necessary for connection to the network interface 1048 includes, for exemplary purposes only, internal and external technologies such as, modems including regular telephone grade modems, cable modems and DSL modems, ISDN adapters, and Ethernet cards.

What has been described above includes examples of the subject innovation. It is, of course, not possible to describe every conceivable combination of components or methodologies for purposes of describing the claimed subject matter, but one of ordinary skill in the art may recognize that many further combinations and permutations of the subject innovation are possible. Accordingly, the claimed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable medium having computer-executable instructions for performing the acts and/or events of the various methods of the claimed subject matter.

There are multiple ways of implementing the present innovation, e.g., an appropriate API, tool kit, driver code, operating system, control, standalone or downloadable software object, etc. which enables applications and services to use the advertising techniques of the invention. The claimed subject matter contemplates the use from the standpoint of an API (or other software object), as well as from a software or hardware object that operates according to the advertising techniques in accordance with the invention. Thus, various implementations of the innovation described herein may have aspects that are wholly in hardware, partly in hardware and partly in software, as well as in software.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

What is claimed is:

1. A system that facilitates collecting a portion of health data from a collection of users, comprising:
an interface component that receives health data communicated from a collection of users, each user within the collection is associated with a respective portion of health data;
a verification component that authenticates at least one of a transmission source of the portion of health data, an ownership between a portion of health data and a user, an integrity level associated with the portion of health data, or a user submitting the portion of health data;
a collection component that aggregates authenticated health data into a semantic data store, the health data is indicative of a raw and unmolested source of health information from the collection of users; and
the collection component organizes the health data to facilitate identification of a medical related trend.

2. The system of claim 1, the semantic data store stores a meaning of the collected health data as a fact about an object.

3. The system of claim 1, the health data is at least one of a portion of low resolution data or a portion of high resolution data, wherein the health data includes at least one of a portion of text, a portion of audio, a portion of video, a portion of imagery.

4. The system of claim 3, the health data is a portion of emotional data, the portion of emotional data is descriptive of at least one of a user's condition, a user's state, or a user's feelings.

5. The system of claim 3, the health data is a portion of physiological data, the portion of physiological data is at least one of a medical related measurement, a medical statistic, or a level related to a wellness.

6. The system of claim 3, the health data is at least one of a portion of demographic data, a portion of trusted third-party healthcare information, a portion of inference data, or a portion of dynamic health sensed data.

7. The system of claim 1, further comprising a device that at least one of detects the health data or communicates the health data, the device is at least one of a heart monitor, a sphygmomanometer, a respirator, a thermometer, a cellular device, an application, a portion of software, a mobile device, a gaming console, a portable gaming device, a media player, a communication device, a pager, a messaging device, a watch, a ring, an article of clothing, a portable digital assistant (PDA), a smartphone, an item of jewelry, a global positioning system (GPS) device, an accelerometer, a motion detector, or a sensor.

8. The system of claim 1, the collection component employs a privacy technique that provides a granular level of exposure for data health data in accordance to a user preference for identity protection.

9. The system of claim 1, further comprising an evaluation engine that analyzes the aggregated health data in order to generate at least one of a predicted outcome, a medical related trend, a determined diagnosis, a portion of medical advice, an interpretation of a user condition, or a reliable insight from a medical viewpoint.

10. The system of claim 9, the evaluation engine creates a model based in part upon analysis of the health data, the model facilitates generating the at least one the predicted outcome, the medical related trend, the determined diagnosis, the portion of medical advice, the interpretation of a user condition, or the reliable insight from a medical viewpoint.

11. The system of claim 10, the model is at least one of a generic model template created based upon analysis from a plurality of users or a user-specific model created based upon analysis from a particular user.

12. The system of claim 11, the evaluation engine provides at least one generic model template to a user, the user personally tailors the generic model template based on a preference.

13. The system of claim 11, the evaluation engine automatically identifies a generic model template for a user and adapts the model to the user based on user interaction with a portion of data.

14. The system of claim 1, further comprising an extractor component that automatically identifies and collects a portion of data relevant to health from at least one of a computer, a laptop, a mobile device, a smartphone, an email application, a text messaging application, a data store, a document, or a communication.

15. The system of claim 1, further comprising a cloud that incorporates at least one of the collection component, the verification component, the data store, and/or the interface.

16. The system of claim 15, the cloud is a collection of resources maintained by a party and accessible by an identified user over a network.

17. A computer-implemented method that facilitates evaluating collected health data in order to predict a reliable outcome or diagnosis for an individual, comprising:
gathering health data from a population of users, the health data is raw and unmolested;
authenticating the gathered health data;
incorporating a privacy preference in accordance with a user that contributes such health data;
organizing the health data in a semantic data store to facilitate identification of a relationship;
automatically identifying health data associated with a user from a device;
analyzing the organized health data in order to determine at least one of a correlation, a trend or a potential outcome; and
enabling a user to interface with health data by leveraging at least one of a cloud or the semantic data store.

18. The method of claim 17, further comprising creating a model based in part upon analysis of the health data, the model is at least one of a generic model template created based upon analysis from a plurality of users or a user-specific model created based upon analysis from a particular user.

19. The method of claim 17, further comprising storing a meaning of a portion of the collected health data as a fact about an object within the semantic data store.

20. A computer-implemented system that facilitates aggregating a portion of health data from a collection of users, comprising:
means for receiving health data communicated from a collection of users, each user within the collection is associated with a respective portion of health data;
means for authenticating at least one of a transmission source of the portion of health data, an ownership between a portion of health data and a user, an integrity level associated with the portion of health data, or a user submitting the portion of health data;
means for aggregating authenticated health data into a semantic data store, the health data is indicative of a raw and unmolested source of health information from the collection of users;
means for organizing the health data to facilitate identification of a medical related trend;
means for analyzing the aggregated health data in order to generate at least one of a predicted outcome, a medical related trend, a determined diagnosis, a portion of medical advice, an interpretation of a user condition, or a reliable insight from a medical viewpoint; and
means for automatically identifying and collecting a portion of data relevant to health from at least one of a computer, a laptop, a mobile device, a smartphone, an email application, a text messaging application, a data store, a document, or a communication.
